(19) United States
(12) Patent Application Publication
(10) Pub. No.: US 2003/0016916 A1
(43) Pub. Date: Jan. 23, 2003

(54) Modular multi-fiber/conductor connector and insert

(76) Inventors: Mark D. Allen, San Diego, CA (US); Elly N. Chung, San Diego, CA (US); Denton S. Seilhan, San Diego, CA (US); Alan V. Bray, Spicewood, TX (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/176,123

(22) Filed: Jun. 18, 2002

Related U.S. Application Data
(60) Provisional application No. 60/305,238, filed on Jul. 13, 2001.

(51) Int. Cl. G02B 6/38

(52) U.S. Cl. 385/55

(57) ABSTRACT

Underwater fiber optic connectors and methods of such connection are described wherein a first optical fiber and a first o-ring are positioned in a first connector portion. The first o-ring acts as a fulcrum between the first fiber and the first connector portion such that the first fiber is free to become nonparallel with a longitudinal axis of the first connector portion. The connectors and methods of connection can further comprise a second optical fiber and a second o-ring positioned within a second connector portion. Again, the second o-ring acts as a fulcrum between the second fiber and the second connector portion such that the second fiber is free to become nonparallel with a longitudinal axis of the second connector portion.

### RELATED APPLICATIONS

This application claims priority from U.S. Patent Application No. 60/305,238, filed on Jul. 13, 2001, which is incorporated herein in its entirety.

### GOVERNMENTAL RIGHTS

The U.S. government has certain rights in this invention as provided for by the terms of NAVSEA Contract Number N0024-00-C-4017 awarded by NAVSEA.

### BACKGROUND OF THE INVENTION

1. Field of the Invention

The present invention relates generally to the field of connectors and more specifically to fiber-optic and electrical connectors capable of underwater application.

2. Description of the Related Technology

The field of electrical connectors is long developed and the market for quality underwater connectors has experienced steady growth since the 1960's. Today, underwater connectors are still used extensively in ocean related military applications, including submarines and other mobile vehicle applications, in underwater research and exploration activities, in ocean mining, and in offshore oil production.

In the design of underwater connectors, several environmental parameters must be considered. A serious consideration is the exposure to extremely high water pressure at deep ocean operating depth. These pressures can crush or otherwise deform connectors not properly designed to withstand such pressure. High pressure, water tight seals may also be provided as water ingress may lead to short circuiting of electrical contacts and otherwise foul the connector components. Connector materials in contact with salt water experience corrosion processes as well. At very great depths below the surface of the sea, the temperature of the seawater may approach freezing temperatures. Thus, connectors used in such environments will experience extreme external temperatures and pressures as well as hostile corrosive effects.

In addition to the above-described characteristics, the development of more sophisticated underwater electrical devices has created a need for connectors of small size and high contact density requiring not only electrical connections, but fiber optic connections as well. As connectors get smaller, many design challenges arise. Thinner wall thickness of materials that make up the connector cannot withstand the high pressure experienced in deep sea applications. Additionally, small components of connectors in such applications may be difficult to manipulate, thus increasing the incidence of connector and wiring damage during connector assembly and use.

Because of the various structural impediments to reducing connector sizes and the hostile environment such connectors experience in deep sea applications, there is a need for a miniature under sea connector which can utilize fiber optic terminations that can withstand the pressure, temperature and corrosive effects of the deep sea, and which can permit proper alignment of fiber optic leads.

### SUMMARY OF CERTAIN INVENTIVE ASPECTS

The systems and methods have several features, no single one of which is solely responsible for its desirable attributes. Without limiting the scope as expressed by the claims that follow, its more prominent features will now be discussed briefly. After considering this discussion, and particularly after reading the section entitled “Detailed Description of the Preferred Embodiments” one will understand how the features of the system and methods provide several advantages over traditional systems and methods.

One aspect is a fiber optic connector for underwater use, comprising a first connector portion having a first cylindrical insert and a first fiber, wherein the first fiber has a first seal to mate with the first cylindrical insert, and wherein the first seal provides a fulcrum to allow the first cylindrical insert and the first fiber to become axially nonparallel. The aspect also has a second connector portion comprising a second cylindrical insert and a second fiber, wherein the second fiber has a second seal to mate with the second cylindrical insert, and wherein the second seal provides a fulcrum to allow the second cylindrical insert and the second fiber to become axially nonparallel.

In another aspect, the first connector portion includes a spring configured to bias the first fiber toward a point of connection with the second fiber of the second connector portion. Another aspect comprises a connector shell, wherein the connector shell encapsulates the first and second connector portions. In some aspects, the connector shell comprises a generally cylindrical watertight cover for the first and second connector portions.

In yet another aspect, an underwater fiber optic connector is described, comprising a first optical fiber, a first connector portion having a first o-ring and the first fiber located therewithin, wherein the first o-ring acts as a fulcrum between the first fiber and the first connector portion such that the first fiber is free to become nonparallel with a longitudinal axis of the first connector portion. This aspect further comprises a second optical fiber, and a second connector portion having the second fiber and a second o-ring located therewithin, wherein the second o-ring acts as a fulcrum between the second fiber and the second connector portion such that the second fiber is free to become nonparallel with a longitudinal axis of the second connector portion.

In another aspect, an underwater fiber optic connector for connecting a first fiber lead and a second fiber lead is disclosed comprising a dynamic connector portion having a lead assembly formed by encasing the first fiber lead within a substantially tubular first fiber lead holder and locating the first fiber lead holder within a first insert. The first fiber lead holder has a first annular seal on its outside surface that acts as a fulcrum between the first insert and the first fiber lead holder. Also included is a static connector portion having a lead assembly formed by encasing the second fiber lead within a substantially tubular second fiber lead holder and locating the second fiber lead holder within a second insert. The second fiber lead holder has a second annular seal on its outside surface that acts as a fulcrum between the second insert and the first fiber lead holder. The first and second fiber lead holders are moveable to become nonparallel with the axes of the first and second inserts, respectively, as necessary to maintain an optical signal connection between the first and second fiber leads.

Another aspect includes a method of underwater fiber optic connection of two optical fibers in a connector having a first side and a second side, comprising positioning the first and second optical fibers in first and second sides by fulcruming o-ring that allow for slight nonparallel misalignment of the optical fibers with their respective connector sides.

Another aspect includes a method of connecting two leads in an underwater fiber optic connector, comprising housing the two leads in the connector utilizing fulcruming o-rings to seal the two leads in the connector in a manner such that the two leads are capable of slight axial misalignment with the connector.

### BRIEF DESCRIPTION OF THE DRAWINGS

FIG. 1 is a cross sectional view of an embodiment of the present invention illustrating the connector in a coupled configuration.

FIG. 2 is a cross sectional side view of the dynamic connector and static connector ends in a decoupled configuration.

FIG. 3 is a cross sectional end view of the retainer illustrating both fiber optic leads and electrical leads.

FIG. 4 is a cross sectional end view of the insert.

FIG. 5 is an end view of the dynamic insert illustrating the terminal leads engaged with the insert.

FIG. 6 is a cross sectional side view of an exemplary capillary holder.

FIG. 7 is a cross sectional side view of an exemplary pin assembly.

### DETAILED DESCRIPTION OF CERTAIN INVENTIVE EMBODIMENTS

Embodiments of the invention will now be described with reference to the accompanying figures, wherein like numerals refer to like elements throughout. The terminology used in the description presented herein is not intended to be interpreted in any limited or restrictive manner simply because it is being utilized in conjunction with a detailed description of certain specific embodiments of the invention. Furthermore, embodiments of the invention may include several novel features, no single one of which is solely responsible for its desirable attributes or which is essential to practicing the inventions herein described.

As submarine towed array and underwater telemetry cable diameters get smaller and measurement technology becomes more dependent upon fiber optic cables and sensors, the fiber optic connectors that interface array and cable segments must also get smaller. Embodiments practicing this disclosure may include a small modular fiber/electrical connector for deep sea or downhole use. One embodiment is designed for use as an underwater array connector that could carry as many as 10 fiber optic contacts and two electrical contacts in a package that had heretofore carried no more than seven total channels. Such a connector could be used for advancing submarine array technology as well as paving the way for advanced telemetry retrieval systems in any environment requiring watertight and corrosion resistant coupling for electrical or fiber optic connectors or both.

Connectors secure two or more leads together and house the connection hardware necessary to allow a union of those leads to pass the signal from one lead to another; the leads being either optical fibers or wires or both. Typical underwater connector fiber optic contacts are flat or spherically polished, and achieve a back reflection of around −40 dB. Back reflection impedes the transmission of signals through fiber optic mediums, and it is desirable to have the lowest back reflection possible. In some embodiments, lower back reflection is achieved by utilizing an angle physical contact (APC), or similar commonly known termination scheme. An APC contact typically utilizes a complimentary 8° angle cut on the end of each of the leads at the fiber interface. It is desirable to ensure the two leads are correctly aligned axially and angularly so as to have accurate contact of the angled ends of the leads. In one embodiment, this is achieved by keying and indexing the housing of the terminals to insure that all fiber channels can be mated in the proper orientation for the APC termini. APC termination is one method of lowering back reflection, but many other termination schemes are possible and are included within the invention.

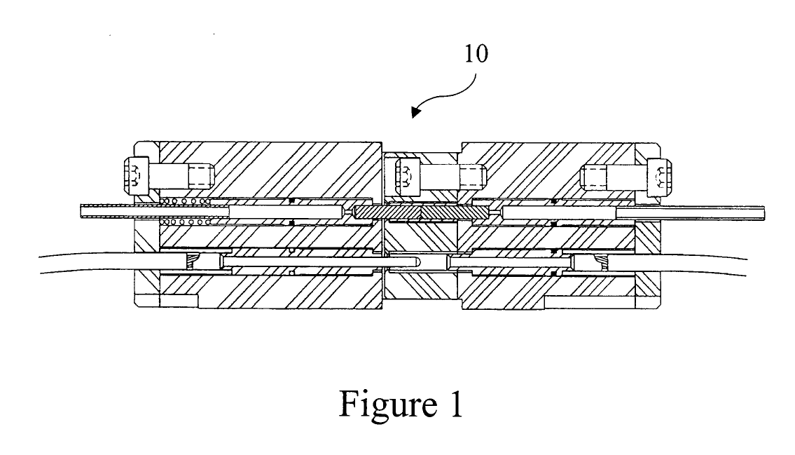

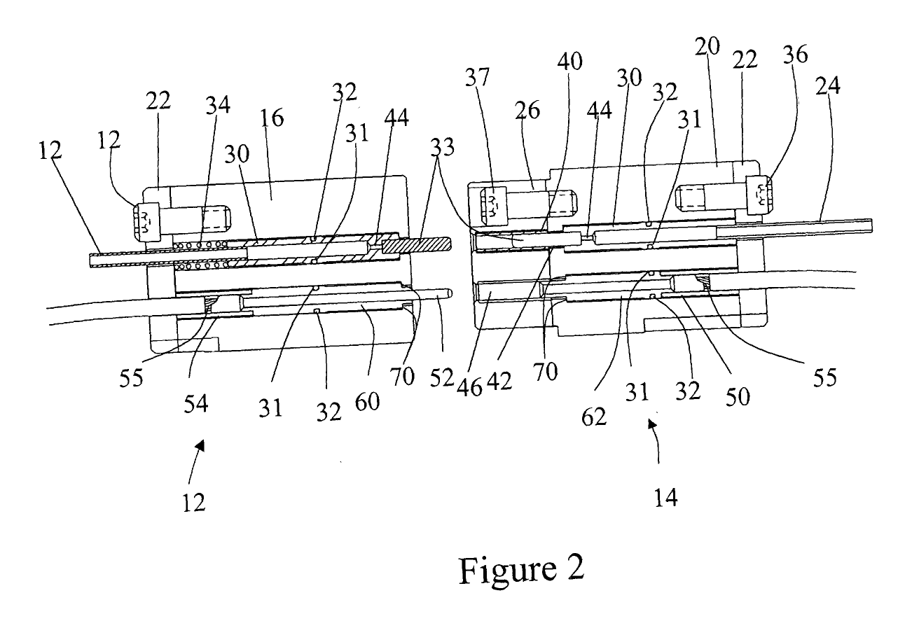

FIG. 1 is a cross sectional side view illustrating a schematic overview of one embodiment of a connector 10 in the mated position. This illustration shows exemplary details of both the fiber and electrical contacts for a connector having multiple fiber and conductor leads. Note that one side of the connector contains dynamic or movable fiber contact assemblies (note the spring 34 identified in FIG. 2), while the other side illustrates static fiber contact assemblies. The electrical contacts may be isolated from the stainless steel insert by an insulating sleeve made of a material such as, for example, an injection molded composite. The fiber optic leads are housed within the connector in capillary holders that isolate them mechanically from the inserts, but can be moveable inside the inserts thereby allowing for motion of the leads to maintain an optimum connection while the connector undergoes movement and pressure transients. Miniaturization achieved in one embodiment is a diameter of the connector body of 0.625 inches or less. A shell is typically utilized with and encapsulates the connector but is not illustrated here. The shell used for any particular embodiment will depend on the requirements of that use and will have the appropriate characteristics to meet those requirements. Several shells that are manufactured may be used for the connector and are contemplated herein.

FIG. 2 is a cross sectional view of a simplified example of a dynamic connector 12 and a static connector 14. A number of design features are illustrated by the figure. In this embodiment, each incoming fiber optic or electrical lead is individually booted to the connector for increased waterproof sealing. The connector 10 comprises two inserts 16, 20, which form the housing for most of the connector components. The inserts 16, 20 are generally cylindrical rods through which a number of holes are bored for housing the electrical and fiber conductors. The holes extend through the inserts axially and the number of bored holes depends on the number of leads required by the particular application in which the connector 10 is to be used. The inserts 16, 20 may be made of a durable and strong metal, however certain embodiments may utilize high strength polymers. At small diameters, the wall thickness of the connector decreases, and stainless steel, inconel, monel, k-monel or similar metals provide the strength needed for the shock, shear, stress, fatigue and other strength related conditions the connector components will experience. In addition, a metal insert provides a satisfactory receptacle for a keyway in applications utilizing a keyed APC termination. For applications in which the connector 10 will not experience the extreme conditions of the deep sea, lower strength materials may be utilized as well.

FIG. 2 also shows some of the construction and engagement of the inserts 16, 20 and their electrical and fiber contact assemblies. A plurality of leads 44, 55 to be connected are housed within an assortment of components in the inserts 16, 20. The leads, whether electrical cable 55 or fiber optic cable 44, have ends that are to be connected. For the fiber optic lead 44, a ferrule 33 may be fit on the end of the lead 44 to increase the quality of the connection. The ferrule 33 is generally a tube having an inside diameter larger than the lead 44 and may have an outside diameter large enough to fill the appropriate hole through the insert 16, 20. The ferrule 33 has two ends, a first end proximate to the end of the lead 44 and a second end that is distal to the end of the lead 44. The ferrule 33 surrounds the end of the lead 44 and acts as a guide to accurately position and align it with the complimentary lead 44 from the other insert 16, 20. In one embodiment, the ferrule 33 is attached to the lead 44 with a commonly known adhesive technique and may be made of zirconia or other suitable material. An example adhesive technique uses an epoxy adhesive.

Also mounted coaxially about the lead 44 and proximate to the second end of the ferrule 33 is a tube 24. The tube 24 may be an elongated tube mounted coaxially about the lead 44 but away from the ferrule 33 by a small distance. The tube 24 provides structural strength to the lead 44 where it enters the insert 16, 20 by guiding it into insert 16, 20 in a straight path to prevent any binding or kinking, which could degrade performance. The lead 44, ferrule 33 and tube 24 all fit coaxially within a capillary holder 30, which fits snugly into the holes that were bored into each of the inserts 16, 20. The capillary holders 30 are generally tubular members having a first end proximate to the ferrule 33 and a distal, second end facing the tube 24. The inside diameter of the capillary holders 30 is generally slightly larger than the fiber lead 44, but has a larger diameter near each end to allow the insertion of, and mating with, the ferrule 33 and the tube 24. In certain embodiments, epoxy or some similar filler material occupies any void between the capillary holder 30 and the lead 44. The tube 24 may be affixed to the mating portion of the capillary holder 30 utilizing any suitable technique, such as adhesive, press fitting, or electron beam welding.

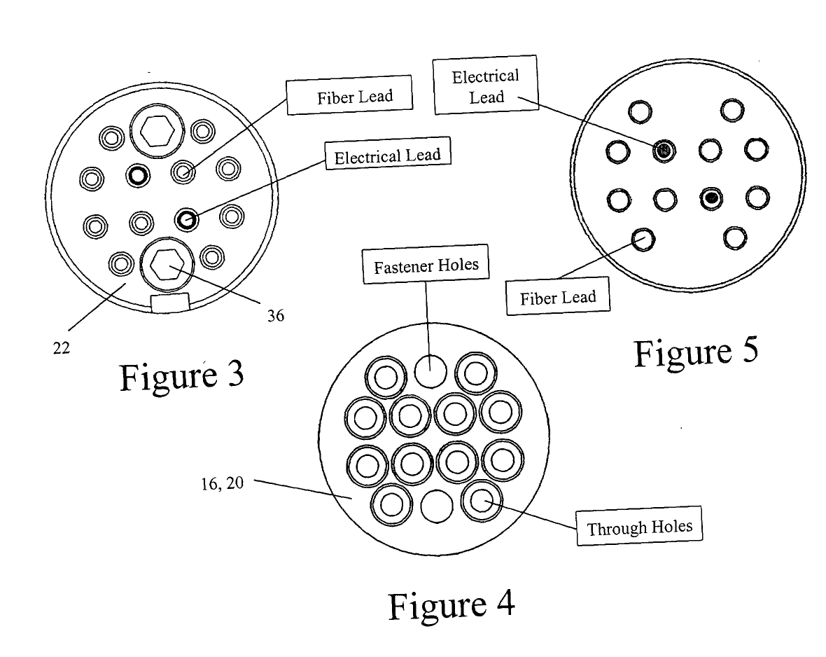

An o-ring seal 32 and corresponding o-ring groove 31 are positioned near the midpoint of the outer surface of the capillary holder 30. The o-ring seal 32 is compressed between the inner surface of the holes bored into the inserts 16, 20 and the outer surface of the capillary holder 30 to form a watertight barrier. Additionally, the o-ring groove 31 may be raised slightly from the outer surface of the capillary holder 30. This allows an engagement between the capillary holder 30 and the holes bored into the inserts 16, 20 that occurs only at one point along the longitudinal axis of the capillary holder 30 thereby allowing the capillary holder 30 to slightly axially misalign with the insert as necessary to maintain proper alignment between the two fiber leads 44 during shock or manipulation of the connector 10. This assists in maintaining a satisfactory optic connection through various mechanical agitating transients that a connector in various applications may experience. A retainer 22, discussed below with regard to FIG. 3, captures the capillary holder 30, lead 44 and ferrule 33 into the insert 16, 20. Each retainer 22 is generally a disc that may be roughly the same diameter as the inserts 16, 20 and has two sets of holes through it. One set of holes allows the passage through of the tubes 24 and the other set of holes are complimentary to a set of similar holes in the end of the insert 16, 20 that are designed to accept one or more fasteners 36. One example of such fasteners are socket cap screws which are threaded bolts with a head larger than the holes in the retainer 22 to bind the retainer 22 to the insert face 16, 20 as the fasteners 36 are tightened. Any suitable fasteners may be used, however.

The set of holes through the retainers 22 that house the tubes 24 are slightly smaller than the outside diameter of the capillary holders 30 thereby capturing the capillary holders 30, the ferrules 33, the leads 44 and tubes 24 that are attached to them, inside of the inserts 16, 20. At the end of the insert 16, 20 that is near the ferrule 33, the capillary holders 30 are captured by decreasing the bore of the hole through the inserts 16, 20 to a size smaller than the outside diameter of the capillary holders 30. This forms an inner face 70 upon which the capillary holders 30 mate and are pressed against by the force applied by fasteners 36 through the retainers 22. The hole beyond the face 70 is sufficiently large to allow the lead 44 and the ferrule 33 to pass through. The ferrule 33 and lead 44 extend out of the insert a short distance. In certain embodiments, the connector 10 comprises a static connector 14 and a dynamic connector 12 with the previous description applying to both. The dynamic connector 12 may comprise a spring 34 located coaxially about the tube 24 that is compressed between the end of the capillary holder 30 and the face of the retainer 22. The spring 34 resists this compression by pushing the capillary holder 30 forward toward the face 70 of the hole through the insert 16. This embodiment allows the spring 34 to absorb and correct for any relative axial motion between the mating inserts 16, 20, thereby maintaining optimum connection contact despite various adverse conditions such as shock, faulty assembly, fatigue of the components or any other such condition. The static connector 14 may include a spacer 42 that fits between the inner diameter of the hole through the insert 20 and the outer diameter of the ferrule 33 where the ferrule 33 passes through the mating end of the insert 20.

In certain embodiments that include electrical leads, the electrical contacts in the connector 10 have much of the same construction as that of the fiber contacts. A similar sized and shaped hole extends through inserts 16, 20 to house connection terminals for the electrical leads 55. Electrical connection terminals may comprise a male pin 52 and a female socket 46. The pin 52 may be a longitudinal rod having a mating end and a lead end. The mating end may be a rounded termination convex while the lead end may comprise a solder cup for soldering a connection with the end of an electrical lead 55. The pin 52 is made of an electrically conductive material and may be made of a corrosion resistant material such as brass or aluminum. The socket 46 is likewise a generally longitudinal conductor also having a lead end and a mating end. The lead end has a solder cup to allow for a solder connection with the end of a lead 55 and the mating end has a socket shaped to snugly accommodate insertion of the pin 52. The socket 46 is similarly made out of an electrically conductive material and may also be made of a corrosion resistant material such as brass or aluminum. Although the pin 52 and socket 46 may be made of corrosion resistant metals, other conductive materials may also be utilized.

The pin 52 is held in place in the insert 12 by a pin holder 60. The pin holder 60 is shaped very similar to the capillary holder 30 and also has an o-ring seal 32 and an o-ring groove 31 to form a watertight barrier in the connector 10. Similarly, the socket 46 is held in place by a socket holder 62, which has the same shape as the pin holder 60. The pin holder 60 and the socket holder 62 may be made of an electrically insulative and corrosion resistant material such as glass reinforced epoxy, or other dielectric materials. The pin holder 60 may also be captured within the insert 12 by the retainer 22, again having a hole through its face large enough to pass a lead 55 but smaller than the outer diameter of the pin holder 60. A pin spacer 54 may be positioned between the retainer 22 and pin holder 60 to engage the pin further apart from the retainer 22. This allows the solder joint to be housed within insert 16. In the static connector insert 20, the socket holder 62 is similarly combined with a socket spacer 50 to provide the same function, as was described in the dynamic connector insert 16. The pin spacer 54 and socket spacer 50 may both be tubes having an inside diameter that is larger than the outside diameter of the lead 55 and solder cups and have an outside diameter larger than the holes in the face of the retainers 22 through which the leads 55 pass. Similar to the fiber connections described above, the pin holder 60 and socket holder 62 are captured on the mating end in each insert by a face 70 formed by decreasing the diameter of the hole through the insert 16, 20.

Referring to FIGS. 2 and 3, the contact made between the fiber and the electrical conductors in the connectors 12, 14 does not typically occur inside either insert 16, 20, but rather, the connection occurs within a column support 26 positioned between the two inserts 16, 20. In one embodiment, the column support 26 may be an elongated disc having various holes extending through it. A first set of holes is for one or more fasteners 37 that attach the column support 26 to either one of the inserts 16, 20. In FIG. 2, the column support 26 is illustrated as being fastened to the static insert 20, but it will be understood that, in other embodiments, it could just as well be fastened to the dynamic insert 16. The embodiment illustrated in FIG. 2 shows a counter-sunk hole for engaging the fastener 37. In certain embodiments, the fastener 37 is similar to the fastener 36 used to mate the retainers 22 to the inserts 16, 20. In one embodiment, the fasteners 37 are a set of cap screws, but it will be understood that other fasteners may be used. A second set of holes formed in the column support 26 is for the electrical connections. In certain embodiments, these holes are only slightly larger than the outside diameter of the sockets 46 that will fit within them. The pins 52 will engage in the sockets 46 as the static connector 14 and the dynamic connector 12 are brought together to make the connection.

Another set of holes in the column support 26 forms the space in which the optical contacts are made. In embodiments utilizing an APC or similar termination, the hole in the column support 26 and the ferrules 33 may be indexed to one another to ensure proper angular alignment of the contacting leads 44, or the index may occur in the holes of the inserts 16, 20 with the capillary holders 30. In one embodiment, the alignment sleeve 40 is utilized to further ensure that the contact between the leads 44 is correct. The alignment sleeve 40 is generally a tube having a length slightly shorter than the length of the hole through the column support 26 so that it fits securely within the column support 26. The alignment sleeve 40 may also be indexed with the hole in the column support 26 and the ferrules 33 if indexing in this area is desired. The indexing method may be through the use of a keyway and key, simple alignment marks, or another technique. Alternatively, other termination schemes are contemplated. The alignment sleeve 40 may be made of zirconia or other suitable material.

In one embodiment, exit and entry of the fiber leads 44 may be via an 18 gauge 304 stainless steel tube 24 that forms part of the capillary holder 30. In this embodiment, the insert 16, 20 is machined from 316 stainless steel. If titanium were used to make the insert 16, 20, the retainer 22 and the tube 24 could also be made of titanium to minimize or eliminate galvanic coupling. Another reason for utilizing a metal in this embodiment is to provide extra strength, because when the fastener sizes are small, threads formed in composite and polymeric material are more likely to fail in high-pressure, high-strength applications. As mentioned before, this embodiment may also comprise each contact assembly having an individual o-ring seal 32 in roughly the center of the insert 16, 20, as described above. This placement of the o-ring seals 32 provides maximum play or “float” for alignment of the contacts during mating and assembly, as there exists a small gap between the capillary holders 30 and the insert 16, 20 elsewhere inside the insert. This play or “float” can act in concert with the force of the spring 34 to reliably maintain a stationary and secure contact point in about the center of the column support 26 despite any faulty assembly or rough operational conditions. Specifically, the contact may occur near the longitudinal center of the alignment sleeve 40.

In one embodiment, the holes formed in the inserts 16, 20 for the fiber and electrical contact assemblies are generally similar, making them essentially interchangeable in the inserts 16, 20. The holes may be finished to a smooth surface to assure an easy insertion and removal of the contacts. In a fully keyed configuration, which accommodates APC termini, the holders 30 may be keyed to the angle cut on the fiber lead 44. This key (not shown) would then be used to set the capillary holders 30 into the insert body 16,20, which in turn is keyed to the other insert 16, 20. The indexing for the insert/contact interface might be as simple as a scribe mark on the tube 24 being matched with a mark on the insert 16, 20, or a more mechanically robust approach such as an actual keyway and key. The insert 16, 20 design can be made to handle any reasonable keying strategy with minor modification. This may be accomplished, for example, by spacing each contact hole appropriately from the others in the cross section of the inserts 16, 20 to allow for an indexing embodiment.

FIG. 2 also illustrates an embodiment of the capillary holders 30 for the fiber channels. While, the capillary holder 30 for the optical contacts may include a press fit connection to the tube 24, this area may, in some applications, be susceptible to leakage and an alternative design may include an electron beam weld joint or an adhesive used between the capillary holder 30 and the tube 24. However, any form of a joint can be used as was stated above.

The connector 10, in many embodiments, can be used with a shell (not shown) as a housing and many shell designs are available and used in the connector field. The design for the shell requires a few considerations, many of which are dependent on the application for which the connector is used. Designs for the shell may include: a 100×50 mil rectangular keyway to index the orientation of the inserts 16, 20 in the shell and to accommodate proper mating; and o-ring (also not shown) that seal the shell to the inserts 16, 20, which may be located in the connector shell. Furthermore, the connector can be designed so that the inserts 16, 20 can be loaded into the shell from the front or from the back to allow for easier assembly, thereby avoiding passing the shell over the length of the cable, which may be extremely extensive for certain applications. Shells are commonly used for connector inserts and many shell designs are commonly available or are manufactured to be used with specific inserts. Any shell can be used for embodiments of the present inserts with appropriate shell design considerations adapted for the characteristics of the inserts 16, 20 described herein.

The connector 10 may, in one embodiment, be fabricated so as to facilitate a configuration of ten fibers and two #22 electrical contacts. The material used for the inserts 16, 20 may be strong and corrosion resistant, e.g., stainless steel. Certain embodiments of the connector 10 having titanium components may be designed to avoid forming any galvanic couples with stainless steel. In cases where titanium is utilized for the manufacture of connector 10, the shell may be configured in titanium with no dimensional changes. The connector may also be designed to include a survival pressure excursion of 2500 psi. As was previously discussed, a design embodiment may include an electron beam welded joint between the tube 24 and the capillary holder 30 (identified in FIG. 2) to ensure the connector 10 is waterproof at such a pressure.

Optical performance characteristics of the connector 10 require a satisfactory minimum level of back-reflection for each contact. A value of −40 dB for back reflection is typical of a controlled production process using flat or spherical polishing techniques for fiber termini. This value might be maintained as low as −45 dB with extensive production selection, but this tends to drive up the price of the connector 10 and can accrue extensive cable costs as rejections mean cutting back the cable to re-terminate. One way to significantly decrease back reflection is to utilize a high quality termination such as an APC termination scheme as described above. Preservation of polarization is also desirable and may be assisted or enhanced by an APC termination, or similar high-quality connection.

FIG. 3 is an end view of one embodiment of the connector 10 having a configuration of ten fibers and two electrical contacts. Because of the modularity created by making similar holes through inserts 16, 20 (FIG. 2) for both fiber leads 44 and electrical leads 55, the actual location of the electrical contacts can be anywhere in the pin matrix of the connector face. This view illustrates the retainer 22, as being essentially a cap that provides for passage of the leads 44, 55 coming into the connector 10, and acts as the anchored end for the spring 34 loaded contact assemblies. The retainer 22 also provides access for cleaning the contacts via the fasteners 36 at the top and bottom. After removal of the fasteners 36 and the retainer 22, the individual contact assemblies can be removed and cleaned.

FIG. 4 is a cross-sectional view of one embodiment of inserts 16, 20. FIG. 4 illustrates the two sets of holes that are formed in inserts 16, 20, one set for fasteners 36 (FIG. 3) and the other set being through holes for contact assemblies. FIG. 4 illustrates the two diameters that make up the through hole. As mentioned before, the large diameter allows insertion of the contact assemblies, the capillary holders 30, the pin holders 60 and the socket holders 62, while the smaller diameter forms a face 70 to capture the contact assemblies on the mating side of inserts 16, 20. It is also evident from the illustration that the edges of the through holes where they enter the face of the insert 16, 20 are beveled for manufacturing and assembly considerations.

FIG. 5 is an end view of the mating end of a connector 12, 14 of one exemplary embodiment. The plug face view illustrated would be that of the insert 16 in the dynamic connector 12 for the embodiment illustrated in FIG. 2, as there are no fastener holes for mounting the column support 26 upon in this illustration. FIG. 5 again illustrates that the contact arrangement is 10 fiber leads 44 and two electrical leads 55. It will be understood that the number of either type of lead 44, 55 may vary. Furthermore, the number of through holes made in the connector 10 may vary as well providing for more or less possible lead 44, 55 connections from one connector 10 to the next, according to the application.

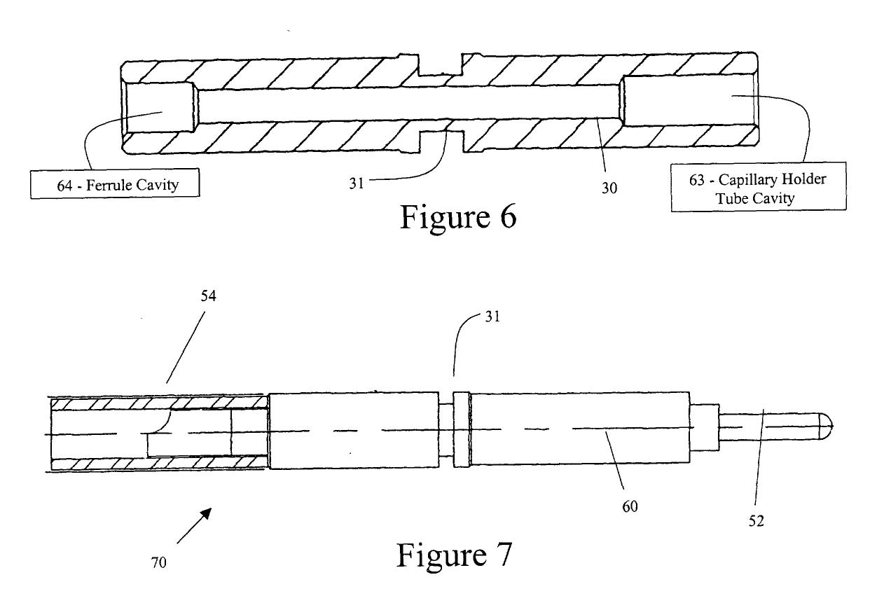

FIG. 6 is a longitudinal cross section of one embodiment of the capillary holder 30. The capillary holder 30 in FIG. 3 illustrates the raised o-ring groove 31 that, together with the o-ring seal 32, form the point of contact between the inside of insert 16, 20 and the outside of capillary holder 30. This singular area of contact allows relative movement of capillary holder 30 inside insert 16, 20. As mentioned before, this relative movement allows the connector to maintain adequate contact of the terminal leads 44 during mechanical agitation such as shock and to compensate in some manner for faulty installation. FIG. 6 also illustrates the cavities in the ends of the capillary holder 30 for accepting the ferrule 33 and the tube 24 (FIG. 2) indicated as such. The cavities are appropriately sized for the particular type of adhesion used for each joint. In the tube 24 to capillary holder 30 joint the cavity 63 may be the appropriate size for a press fit joint in some embodiments or may be the appropriate size for other joints, such as electron beam welding or epoxy, as the application dictates. The ferrule cavity 64 may be sized appropriately for a press fit between the ferrule 33 and the capillary holder 30 but may also be an appropriate size for whatever other joint is utilized as well. As mentioned before, in embodiments where the diameter of the lead 44 is smaller than the inner diameter of capillary holder 30 the void between the ferrule 33 and the tube 24 may be filled with epoxy or other suitable filler material.

FIG. 7 is a side view of an embodiment of a pin contact assembly 70 including a cross sectional view of the pin spacer 54. The pin contact assembly 70 can comprise pin 52, pin holder 60 and pin spacer 54. FIG. 7 also illustrates, as described above, that the solder cup of the pin 52 can be located within the pin spacer 54 to house the solder joint between pin 52 and electrical lead 55 (FIG. 2). The socket contact assembly may be fabricated in a similar manner to the pin contact assembly 70 to lower manufacturing costs and simplify replacement of parts, however this assembly would utilize the socket 46 and the socket spacer 50. The socket spacer 50 and the pin spacer 54 may be identical to enhance the interchangeability of components for the connector 10.

The electrical contact assemblies are similar in construction, as shown in the sketch of the embodiment of a pin contact 52 and pin holder 60 illustrated in FIG. 7. The pin 52 itself runs the entire length of the holder 60. The pin spacer 54 provides a solid seat against the retainer assembly 22 (FIG. 2). One feature of the electrical contact assemblies is that the pin and socket holders 60, 62 may be made of a nonconductive material. The material to be used may be glass-reinforced epoxy, as stated above, and the mold and the process of fabrication of the pin and socket holders 60, 62 may be any suitable method, such as via injection molding for example.

In one embodiment, the connector 10 will meet the following design specifications:

Basic Connector Configuration and Size:

| | |
|---|---|
| Fiber Count | 10 |
| Electrical Contacts | 2-#22 |
| insert Size: | 0.625 × 2.64 inches |
| Insert Material: | Stainless Steel or Titanium |

Multi-Mode/Single-Mode: The connector design allows single-mode, multi-mode, and electrical contacts in any combination to cover the broadest range of potential uses in commercial and military applications.

Optical Properties:

| | | |
|---|---|---|
| Optical Wavelength | 1530-1565 | nm |
| Optical Insertion Loss per Pin | <0.5 | dB |
| Back Reflection per Pin-Standard MMFC | <−40 | dB |
| Back Reflection per Pin-APC MMFC | <−60 | dB |
| Transient Peak Power | 40 | dBm |
| Optical Life Degradation | <1.5 | dB |

Operational Parameters

| | |
|---|---|
| 150 Mate/Demate Degradation | <1.5 dB with Each |
| | Cycle Cleaning |
| ISOPAR L Resistance | Low Swell Attack |
| Operating Temperature | −20 C. to +400 C. |
| Storage Temperature | −280 C. to +650 C. |
| Pressure | 2500 psi Survival |
| | 1200 psi Operational |

The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

What is claimed is:

1. A fiber optic connector for underwater use, comprising:
a first connector portion comprising a first cylindrical insert and a first fiber, wherein the first fiber has a first seal to mate with the first cylindrical insert, and wherein the first seal provides a fulcrum to allow the first cylindrical insert and the first fiber to become axially nonparallel; and
a second connector portion comprising a second cylindrical insert and a second fiber, wherein the second fiber has a second seal to mate with the second cylindrical insert, and wherein the second seal provides a fulcrum to allow the second cylindrical insert and the second fiber to become axially nonparallel.

2. The connector of claim 1, wherein the first connector portion includes a spring configured to bias the first fiber toward a point of connection with the second fiber of the second connector portion.

3. The connector of claim 1, further comprising a connector shell, wherein the connector shell encapsulates the first and second connector portions.

4. The connector of claim 3, wherein the connector shell comprises a generally cylindrical watertight cover for the first and second connector portions.

5. The connector of claim 1, further comprising first and second lead tubes that guide each of the first and second fibers into the first and second connector portions, respectively.

6. The connector of claim 1, further comprising a spacer that is generally cylindrical and forms a location for a point of connection of the first and second fibers.

7. The connector of claim 6, wherein the spacer is attached to the first connector portion.

8. The connector of claim 6, wherein the spacer is attached to the second connector.

9. The connector of claim 1, further comprising a retainer for retaining the first fiber within the first connector portion.

10. The connector of claim 1, wherein the first and second fibers are located in respective holes running longitudinally through the first and second connector portions.

11. The connector of claim 10, wherein the first and second connector portions each have more than one of the holes located therein.

12. The connector of claim 10, wherein the holes are configured to contain either a fiber or an electrical lead.

13. An underwater fiber optic connector, comprising:
a first optical fiber;
a first connector portion having a first o-ring and the first fiber located therewithin, wherein the first o-ring acts as a fulcrum between the first fiber and the first connector portion such that the first fiber is free to become nonparallel with a longitudinal axis of the first connector portion;
a second optical fiber; and
a second connector portion having the second fiber and a second o-ring located therewithin, wherein the second o-ring acts as a fulcrum between the second fiber and the second connector portion such that the second fiber is free to become nonparallel with a longitudinal axis of the second connector portion.

14. The connector of claim 13, wherein the first connector portion includes a spring configured to bias the first fiber toward a point of connection with the second fiber of the second connector portion.

15. The connector of claim 13, further comprising a connector shell, wherein the connector shell encapsulates the first and second connector portions.

16. The connector of claim 15, wherein the connector shell comprises a generally cylindrical watertight cover for the first and second connector portions.

17. The connector of claim 13, further comprising first and second lead tubes that guide each of the first and second fibers into the first and second connector portions, respectively.

18. The connector of claim 13, further comprising a spacer that is generally cylindrical and forms a location for a point of connection of the first and second Fibers.

19. The connector of claim 18, wherein the spacer is attached to the first connector portion.

20. The connector of claim 18, wherein the spacer is attached to the second connector portion.

21. The connector of claim 13, further comprising a retainer for retaining the first fiber within the first connector portion.

22. The connector of claim 13, wherein the first and second fibers each are located in respective holes running longitudinally through the first and second connector portions.

23. The connector of claim 22, wherein the first and second connector portions each have more than one of the holes located therein.

24. The connector of claim 22, wherein the holes are configured to contain either a fiber or an electrical lead.

25. An underwater fiber optic connector, comprising:
a substantially cylindrical first connector portion having a first fiber located within the first connector portion and substantially parallel with an axis of the first connector portion, wherein the first fiber is loosely contained so that, upon connection, the first fiber may become nonparallel with respect to the first connector portion; and
a substantially cylindrical second connector portion having a second fiber located within the second connector portion and substantially parallel with an axis of the second connector portion, wherein the second fiber is loosely contained so that, upon connection, the second fiber may become nonparallel with respect to the second connector portion.

26. The connector of claim 25, wherein the first connector portion includes a spring configured to bias the first fiber toward a point of connection with the second fiber of the second connector portion.

27. The connector of claim 25, further comprising a connector shell, wherein the connector shell encapsulates the first and second connector portions.

28. The connector of claim 27, wherein the connector shell comprises a generally cylindrical watertight cover for the first and second connector portions.

29. The connector of claim 25, further comprising first and second lead tubes that guide each of the first and second fibers into the first and second connector portions, respectively.

30. The connector of claim 25, further comprising a spacer that is generally cylindrical and forms a location for a point of connection of the first and second fibers.

31. The connector of claim 30, wherein the spacer is attached to the first connector portion.

32. The connector of claim 30, wherein the spacer is attached to the second connector.

33. The connector of claim 25, further comprising a retainer for retaining the first fiber within the first connector portion.

34. The connector of claim 25, wherein the first and second fibers are located in respective holes running longitudinally through the first and second connector portions.

35. The connector of claim 34, wherein the first and second connector portions each have more than one of the holes located therein.

36. The connector of claim 34, wherein the holes are configured to contain either a fiber or an electrical lead.

37. An underwater fiber optic connector for connecting a first fiber lead and a second fiber lead, the connector comprising:
a dynamic connector portion having a lead assembly formed by encasing the first fiber lead within a substantially tubular first fiber lead holder and locating the first fiber lead holder within a first insert, wherein the first fiber lead holder has a first annular seal on its outside surface that acts as a fulcrum between the first insert and the first fiber lead holder; and
a static connector portion having a lead assembly formed by encasing the second fiber lead within a substantially tubular second fiber lead holder and locating the second fiber lead holder within a second insert, wherein the second fiber lead holder has a second annular seal on its outside surface that acts as a fulcrum between the second insert and the first fiber lead holder;
wherein the first and second fiber lead holders are moveable to become nonparallel with the axes of the first and second inserts, respectively, as necessary to maintain an optical signal connection between the first and second fiber leads.

38. The connector of claim 37, wherein the dynamic connector portion includes a spring configured to bias the first fiber lead toward a point of connection with the second fiber of the static connector portion.

39. The connector of claim 37, further comprising a connector shell, wherein the connector shell encapsulates the static and dynamic connector portions.

40. The connector of claim 39, wherein the connector shell comprises a generally cylindrical watertight cover for the dynamic and static connector portions.

41. The connector of claim 37, further comprising first and second lead tubes that guide each of the first and second fibers into the dynamic and static connector portions, respectively.

42. The connector of claim 37, further comprising a spacer that is generally cylindrical and forms a location for a point of connection of the first and second fiber leads.

43. The connector of claim 42, wherein the spacer is attached to the dynamic connector portion.

44. The connector of claim 42, wherein the spacer is attached to the static connector portion.

45. The connector of claim 37, further comprising a retainer for retaining the first fiber lead within the dynamic connector portion.

46. The connector of claim 37, wherein the first and second fiber leads are located in respective holes running longitudinally through the dynamic and static connector portions.

47. The connector of claim 46, wherein the dynamic and static connector portions each have more than one of the holes located therein.

48. The connector of claim 46, wherein the holes are configured to contain either a fiber lead or an electrical lead.

49. A method of underwater fiber optic connection of two optical fibers in a connector having a first side and a second side, wherein the method comprises positioning the first and second optical fibers in first and second sides by fulcruming o-rings that allow for slight nonparallel misalignment of the optical fibers with their respective connector sides.

50. In a fiber optic connector, a method of connecting first and second optical fibers respectively housed in first and second connector halves that are brought together to form a connection, the method comprising:
housing the first optical fiber in the first connector half with a fulcruming first o-ring;
housing the second optical fiber in the second connector half with a fulcruming second o-ring; and
joining the first and second connector halves, wherein the fulcruming first and second o-ring allow slight parallel misalignment of the first and second optical fibers with respective axes of the first and second connector halves.

51. A method of connection of two leads in an underwater fiber optic connector, wherein the method comprises housing the two leads in the connector utilizing fulcruming o-rings to seal the two leads in the connector in a manner such that the two leads are capable of slight axial misalignment with the connector.

52. A method of connecting first and second optical leads with a fiber optic connector for use underwater, the method comprising:
encasing the first and second optical leads in first and second substantially tubular lead holders, thereby forming first and second lead assemblies each having an annular seal near its longitudinal center;
inserting each of the first and second lead assemblies into respective first and second substantially cylindrical inserts, wherein each of the annular seals forms a dynamic joint between an inner surface of each of the inserts and an outer surface of each of the lead assemblies, and wherein each of the annular seals forms a fulcrum between its respective lead assembly and insert such that the lead assemblies are moveable to axially misalign from an axis of the inserts.

53. An underwater fiber optic connector having first and second optical leads respectively housed in first and second connector portions that are brought together to form an underwater fiber optic connection, comprising:
means for housing the first optical lead in the first connector portion, wherein the first optical lead is moveable to a nonparallel position with respect to an axis of the first connector portion;
means for housing the second optical lead in the second connector portion, wherein the second optical lead is moveable to a nonparallel position with respect to an axis of the second connector portion, wherein the means for housing the first optical lead in the first connector portion and the means for housing the second optical lead in the second connector portion allow the first and second optical leads to be optically connected.
